(19) United States
(12) Patent Application Publication
(10) Pub. No.: US 2008/0094184 A1
(43) Pub. Date: Apr. 24, 2008

(54) Electronic system having a plurality of individually operable user stations

(76) Inventor: Dr. Gangolf Hirtz, Kronach (DE)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/974,519

(22) Filed: Oct. 12, 2007

(30) Foreign Application Priority Data
Oct. 12, 2006 (DE) 102006048383.9

(51) Int. Cl. G08B 1/00

(52) U.S. Cl. 340/286.01

(57) ABSTRACT

An electronic system is responsive to an operating signal from a single input device for determining which of the plurality of user stations is to be operated and what operation is to be performed. The electronic system includes a first user station that receives a signal at a first magnitude and a second user station that receives the signal at a second magnitude. A control circuit is responsive to the first and second magnitudes of the signal for determining one of the first and second user stations to process the signal.

### CROSS REFERENCE TO RELATED APPLICATION

This application claims priority to German Patent Application No. 102006048383.9 filed Oct. 12, 2006.

### BACKGROUND OF THE INVENTION

This invention relates in general to an electronic system having a plurality of individually operable user stations. In particular, this invention relates to an improved structure for such an electronic system that is responsive to an operating signal from a single input device for determining which of the plurality of user stations is to be operated and what operation is to be performed.

A wide variety of electronic systems are known that each include a plurality of individually operable user stations. For example, in many modern vehicles, an electronic entertainment system is provided for displaying video content on a plurality of individually operable display units. To accomplish this, first and second display units are typically provided on rearwardly facing portions of the front seats of the vehicle for viewing by persons seated in the middle or rear seats of the vehicle. The operations of the first and second display units are usually controlled by an electronic controller that is located in an instrument panel of the vehicle.

In an electronic entertainment system of this general type, it is usually desirable that each of the display units to be individually operable to accommodate the individual desires (such as volume, content, and the like) of the respective persons viewing such display units. In the past, this individual control has been accomplished by providing separate first and second input devices (such as a pair of wireless infrared signal remote control devices) that are respectively and uniquely associated with the first and second display units. Although effective, the use of individual input devices is somewhat inefficient. In other instances, this individual control has been accomplished by providing an input device with a switch for manually selecting one of the first and second display units to be controlled. The use of such an input device with a manual switch is somewhat cumbersome. Thus, it would be desirable to provide an improved structure for an electronic system that is responsive to an operating signal from a single input device for determining which of a plurality of user stations is to be operated and what operation is to be performed.

### SUMMARY OF THE INVENTION

This invention relates to an improved structure for an electronic system that is responsive to an operating signal from a single input device for determining which of the plurality of user stations is to be operated and what operation is to be performed. The electronic system includes a first user station that receives a signal at a first magnitude and a second user station that receives the signal at a second magnitude. A control circuit is responsive to the first and second magnitudes of the signal for determining one of the first and second user stations to process the signal.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a portion of an interior of a vehicle including an electronic system that is responsive to an operating signal from a single input device for determining which of a plurality of user stations is to be operated and what operation is to be performed in accordance with this invention.

FIG. 2 is a block diagram of a first embodiment of the electronic system illustrated in FIG. 1.

FIG. 3 is a flow chart of a method for operating the first embodiment of the electronic system illustrated in FIGS. 1 and 2.

FIG. 4 is a block diagram of a second embodiment of the electronic system illustrated in FIG. 1.

FIG. 5 is a flow chart of a method for operating the second embodiment of the electronic system illustrated in FIG. 4.

### DETAILED DESCRIPTION OF THE PREFERRED EMBODIMENTS

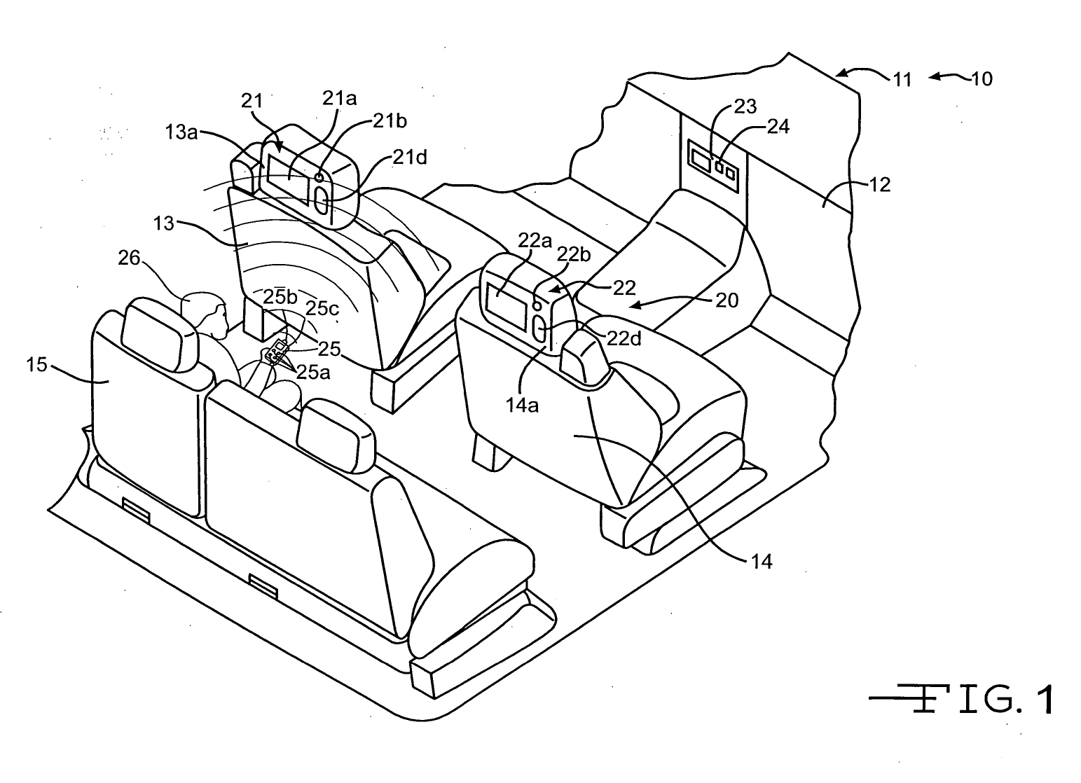

Referring now to the drawings, there is illustrated in FIG. 1 a portion of a vehicle, indicated generally at 10. The illustrated vehicle 10 is, in large measure, conventional in the art and is intended merely to illustrate one environment in which this invention may be used. Thus, the scope of this invention is not intended to be limited for use with the specific structure for the vehicle illustrated in FIG. 1 or with vehicles in general. On the contrary, as will become apparent below, this invention may be used in any desired environment for the purposes described below. The illustrated portion of the vehicle 10 includes an interior passenger compartment 11. The interior passenger compartment 11 may be partially defined by a dash board or instrument panel 12. As illustrated, the interior passenger compartment 11 includes a first front seat 13, a second front seat 14, and a rear seat 15, although such is not required.

The interior passenger compartment 11 of the vehicle 10 further includes a first embodiment of an electronic system 20 in accordance with this invention. The illustrated electronic system 20 is an entertainment system, although such is not required. The first embodiment of the electronic entertainment system 20 includes a first user station 21 and a second user station 22. Each of the first user station 21 and the second user station 22 are individually operable to accommodate the specific desires of the respective passengers viewing and/or hearing the respective first user station 21 and the second user station 22, as will be explained below. As illustrated, the first user station 21 is located within a rearwardly facing portion 13a of the first front seat 13 and the second user station 22 is located within a rearwardly facing portion 14a of the second front seat 14. However, it will be appreciated that the user stations 21 and 22 of the electronic entertainment system 20 may be located anywhere within the vehicle 10. As illustrated, both the first user station 21 and the second user station 22 are positioned within the vehicle 10 such that each can be operated and viewed by passengers seated on the rear seat 15 behind each of the first front seat 13 and the second front seat 14, respectively, although such is not required. It will be appreciated that the electronic entertainment system 20 may have any number of user stations for use in any desired configuration. Ideally, the various components of each of the user stations of the electronic entertainment system 20 are located proximate to the seating location of the passenger intended to view or hear the respective user station. It will further be appreciated that a user station, as used herein, may refer to the main entertainment system in a vehicle, such as an entertainment system suitable to be heard and/or viewed from multiple seating locations throughout the vehicle.

The operation of the electronic entertainment system 20 is controlled by a controller 23, as will be further described below. As illustrated, the controller 23 may be located within the instrument panel 12, although such is not required. It will be appreciated that the controller 23 may be located anywhere within the vehicle 10. As illustrated, the electronic entertainment system 20 may include one or more user controls 24 that are connected to the controller 23 to allow passengers (not shown) that are seated in the first front seat 13 or the second front seat 14 to input commands into the electronic entertainment system 20. It will be appreciated that the user controls 24 are not required in this invention.

The electronic entertainment system 20 further includes an input device 25. The input device 25 may be embodied as any conventional wireless or infrared transmitter device that is capable of transmitting a remote control signal. The input device 25 may include any number or variety of buttons, knobs, or other user-manipulated devices 25a that allow a passenger 26 to select a desired command to be transmitted as the remote control signal. The input device 25 may include circuitry (not shown) for encoding and modulating a remote control signal corresponding to the desired command, as is known in the art. In response to the operation of any one or more of the user-manipulated devices 25a, the input device 25 may transmit an infrared, radio frequency, or any other type of signal as the remote control signal. The input device 25 may transmit the remote control signal corresponding to the desired command using any standard code format, although such is not required. The input device 25 may also include a transmitter 25b that is positioned within the input device 25 such that the transmitter 25b emits a selected remote control signal outwardly from a first end 25c of the input device 25 when any of the user-manipulated devices 25a are operated, although such is not required. The input device 25 may be used to transmit commands to either of the first user station 21 and the second user station 22 of the electronic entertainment system 20, as will be explained in further detail below.

As shown in FIGS. 1 and 2, the first user station 21 includes a first display 21a, a first receiver 21b, and a first processor 21c. The first user station 21 may also include a first speaker 21d and/or other audio devices, such as a wireless headphone set (not shown). The second user station 22 includes a second display 22a, a second receiver 22b, and a second processor 22c. The second user station 22 may also include a second speaker 21d and/or other audio devices, such as a wireless headphone set (not shown). It will be appreciated that each of the first user station 21 and the second user station 22 may include additional various audio or visual devices, and further that the devices of each of the first user station 21 and the second user station 22 may differ from one another. Each of the first user station 21 and the second user station 22 may be individually operable to accommodate the specific desires of the respective passengers that are viewing and/or hearing the first user station 21 and the second user station 22, respectively. For example, the input to the first display 21a and the input to the second display 22a may be independently selectable. Additionally, the volume of the first and second speakers 21d and 22d may be individually controllable. For example, the passenger 26 may want to increase the volume of the first speaker 21d without affecting the volume of other speakers, such as the second speaker 22d, within the vehicle 10.

The first display 21a and the second display 22a may each be embodied as any device that is capable of displaying a video image representative of a video input signal receiver from the controller 23. It will be appreciated that the first display 21a and the second display 22a may receive individual video input signals from the controller 23 that are independent from one another, although such is not required. It will further be appreciated that the first display 21a and the second display 22a are not required to practice this invention. Alternatively, the first user station 21 and the second user station 22 may include other audio or visual devices to be controlled in accordance with this invention.

The first receiver 21b and the second receiver 22b may each be embodied with any device that is capable of receiving the signal transmitted by the input device 25. To accomplish this, each of the first receiver 21b and the second receiver 22b may include an antenna (not shown) and an amplifier (not shown), as is well known in the art, although such is not required.

The first processor 21c and the second processor 22c may be a microprocessor, although such is not required. It will be appreciated that the first processor 21c and the second processor 22c may be embodied as any processing unit or circuitry, either analog or digital, that is operable in the manner described herein. The first processor 21c and the second processor 22c may each include circuitry to determine the strength or magnitude of the signal received by the first receiver 21b and the second receiver 22b respectively. The first processor 21c and the second processor 22c may also each include circuitry to demodulate and decode the signals received from the input device 25 in a manner that is well known in the art, although such is not required. In a preferred embodiment, the first processor 21c and the second processor 22c include respective circuitry to digitize the signal received by the first receiver 21b and the second receiver 22b, respectively, and to determine the strength of each of the signals received. It will be appreciated that each of the signals received by the first receiver 21b and the second receiver 22b may be digitized by the first processor 21c and the second processor 22c in order to define both the desired function to be performed and magnitude of the signal that is received at each of the receivers 21b and 22b.

The controller 23, the first processor 21c, and the second processor 22c form a control circuit 27 for the electronic entertainment system 20. The control circuit 27 may perform any or all of the functions of the controller 23, the first processor 21c, and the second processor 22c. Thus, it will be appreciated that the functions described herein for the first processor 21c associated with the first user station 21 and the functions described herein for the second processor 22c associated with the second user station 22 may be performed by the control circuit 27, such that the controller 23 performs the tasks described for the first processor 21c and the second processor 22c. It will further be appreciated that the functions described herein for the controller 23 may at least partially be performed by the control circuit 27, such that at least one of the first processor 21c and the second processor 22c perform the tasks described for the controller 23. Thus, the locations of the circuitry for performing the functions described herein for the controller 23, the first processor 21c, and the second processor 22c within the vehicle 10 and the electronic entertainment system 20 is not required as described herein for the invention.

The operation of the electronic entertainment system 20 will now be explained. As illustrated, the passenger 26 is seated on the rear seat 15 behind the first user station 21. The passenger 26 is therefore in the desired location for optimal viewing of the first display screen 21a of the first user station 21. When the passenger 26 would like to change the settings of the first user station 21, the passenger 26 holds the input device 25 so that the transmitter 25b is pointed directly toward the first display unit 21a, because that is the device that the passenger 26 desires to control. Due to the proximity of the first receiver 21b to the first display 21a, the input device 25 is also aimed toward the first receiver 21b. It will be appreciated that the first receiver 21b and the second receiver 22b may be located within any portion of the vehicle and do not have to be relatively proximate to the first display 21a and the second display 22a. It will further be appreciated that the passengers of the vehicle 10 may be required to aim the input device 25 toward other targets in the vehicle 10 that may be proximate to the first receiver 21b or the second receiver 22b in order to control the desired user station devices as will be explained herein.

Next, the passenger 26 uses the user-manipulated devices 25a on the input device 25 to select a desired command for the first user station 21. The input device 25 then transmits a signal including a code corresponding to the desired command. Because the first user station 21 and the second user station 22 are relatively close to one another, i.e. physically near each other within the interior passenger compartment 11, both the first receiver 21b and the second receiver 22b will receive the signal transmitted by the input device 25, even if the transmitter 25a of the input device 25 is directed toward one of the first receiver 21b and the second receiver 22b. However, because the passenger 26 generally aims the input device 25 toward the first display 21a and the first receiver 21b, i.e. the desired user station to be controlled, the magnitude or level of signal received by the first receiver 21b will be greater than the magnitude of level of signal received by the second receiver 22b. Because each of the user stations 21 and 22 may include similar components, such as the displays 21a and 22a, which may each respond to the same signal codes transmitted by the input device 25, it is desirable to distinguish which of the user stations 21 and 22 should process the signal transmitted by the input device 25 so that only the desired user station processes the command selected by the passenger 26.

For example, if the passenger 26 aims the input device 25 at the first receiver 21b and selects a desired command (“INCREASE VOLUME”, for example), the input device 25 would transmit a first remote control code. The first receiver 21b would receive this transmitted signal and, in response thereto, the first processor 21c would determine a value for the strength or magnitude of the signal that is received by the first receiver 21b. Because the input device 25 is aimed directly at the first receiver 21b, the magnitude of the transmitted signal that is received by the first receiver 21b is relatively large. A value indicative of this relatively large signal magnitude received by the first receiver 21b is then transmitted to the controller 23 by the first processor 21c. It will be appreciated that the first processor 21c may also decode the signal to determine the desired command that was transmitted, although such is not required. Alternatively, the signal received by the first receiver 21b may be transmitted to the controller 23 for decoding.

Because the second receiver 22b is located near the first receiver 21b, the second receiver 22b would also receive this transmitted signal. In response thereto, the second processor 22c would determine a value for the strength or magnitude of the signal that is received by the second receiver 22b. Because the input device 25 is not aimed directly at the second receiver 22b, the magnitude of the transmitted signal that is received by the second receiver 22b is relatively small in comparison to the relatively large signal magnitude received by the first receiver 21b. A value indicative of this relatively small signal magnitude received by the second receiver 22b is then transmitted to the controller 23 by the second processor 22c. It will be appreciated that the second processor 22c may also decode the signal to determine the desired command that was transmitted, although such is not required. Alternatively, the signal received by the second receiver 22b may be transmitted to the controller 23 for decoding.

In the manner described in detail below, the controller 23 determines which of the signals received by the two receivers 21b and 22b from the input device 25 is larger in magnitude. In response to that determination, it is assumed that the passenger 26 wants to alter the operation of only the user station 21 or 22 that received the larger magnitude signal from the input device 25. Thus, the controller 23 thereafter alters the operation of only the user station 21 or 22 that received the larger magnitude signal from the input device 25.

Referring now to FIG. 3, there is illustrated a flow chart, indicated generally at 30, of a method for operating the first embodiment of the electronic system illustrated in FIGS. 1 and 2. In a first step 31 of the method 30, the controller 23 determines if any signal has been received by the two receivers 21b and 22b from the input device 25. The signal level received at the first user station 21 and the second user station 22 are referred to, respectively, as signal level A and signal level B in FIG. 3. If no such signal has been received by either of the two receivers 21b and 22b from the input device 25, then the method 30 loops back to the first step 31. Thus, the controller 23 continuously checks to see if a signal has been received by either of the two receivers 21b and 22b from the input device 25.

If such a signal has been received by the two receivers 21b and 22b from the input device 25, the method 30 branches from the first step 31 to a second step 32, wherein the controller 23 reads the signals transmitted from both the first processor 21c and the second processor 22c. Then, the method enters a third step 33, wherein the controller 23 determines if the signal level A received by the first receiver 21b is significantly different than the signal level B received by the second receiver 22b. As described above, the signal that is received by each of the receivers 21b and 22b can be digitized using a predetermined number of significant digits to adequately represent both the desired function to be performed and magnitude of the signal that is received at each of the receivers 21b and 22b. The controller 23 may be programmed with a threshold value, such that the difference between the signal levels for either or both of the first and second receivers 21b and 22b must be greater than or equal to the stored threshold value in order for the signal levels to be determined to be significantly different. It will be appreciated that the controller 23 may determine whether or not the signal levels for the first and second receivers 21b and 22b are significantly different by any conventional method.

If, in the third step 33 of the method 30, the controller 23 determines that the signal level A for the first receiver 21a is significantly different than the signal level B for the second receiver 21b, then the method 30 branches to a fourth step 34. In this fourth step 34, the controller 23 selects the receiver 21a or 21b having the larger magnitude signal level. Then, the desired function or command code which corresponds to the signal received by the associated one of the first and second receivers 21a and 21b is processed, as indicated at a fifth step 35 of the method 30. In the above illustration, the first receiver 21b received a larger magnitude signal than the second receiver 22b because the passenger 26 aimed the input device 25 directly at the first receiver 21b. Thus, in this instance, the controller 23 would, in a fifth step 35 of the method 30, select the first user station 21 to process and implement the desired command (“INCREASE VOLUME”, as mentioned above). The controller 23 would not cause any change in the operation of the second user station 22 because the lesser magnitude of the signal received by the second receiver 22b indicates that no change in the operation thereof was desired. Thereafter, the method 30 returns to the first step 31, and the entire process is repeated.

Referring again to the third step 33, it will be appreciated that the controller 23 may compare the signal levels for user station 21 and user station 22, and, if a difference in signal level is distinguishable, the method may advance to step 34. Thus, the controller 23 may compare the signal levels in the third step 33 without regard to any threshold value used to establish whether the signal levels are significantly different. It will further be appreciated that the controller 23 may determine if the signal levels are significantly different by any known method.

If, however, in the third step 33 of the method 30, the controller 23 determines that the signal level A for the first receiver 21a is not significantly different than the signal level B for the second receiver 21b, then the method 30 branches to a sixth step 36. In this sixth step 36, the controller 23 may display a message on the displays 21a and 22a of both of the user stations 21 and 22, respectively, as indicated at 36a. Such a message may, for example, advise the person 26 that no action is being taken because the controller 23 is not able to determine which of the user stations 21 and 22 is desired to change operation. However, the message may contain any desired information. Thereafter, the method 30 returns to the first step 31, and the entire process is repeated. Alternatively, then the controller 23 may select a default one of the first and second user stations 21 and 22 for changing the operation thereof, as indicated at 36b. It will be appreciated that the default user station may be determined and stored according to any conventional method. Thereafter, the method 30 returns to the first step 31, and the entire process is repeated. In another alternative embodiment, the method 30 may simply return directly back to the first step 31, and the entire process is repeated.

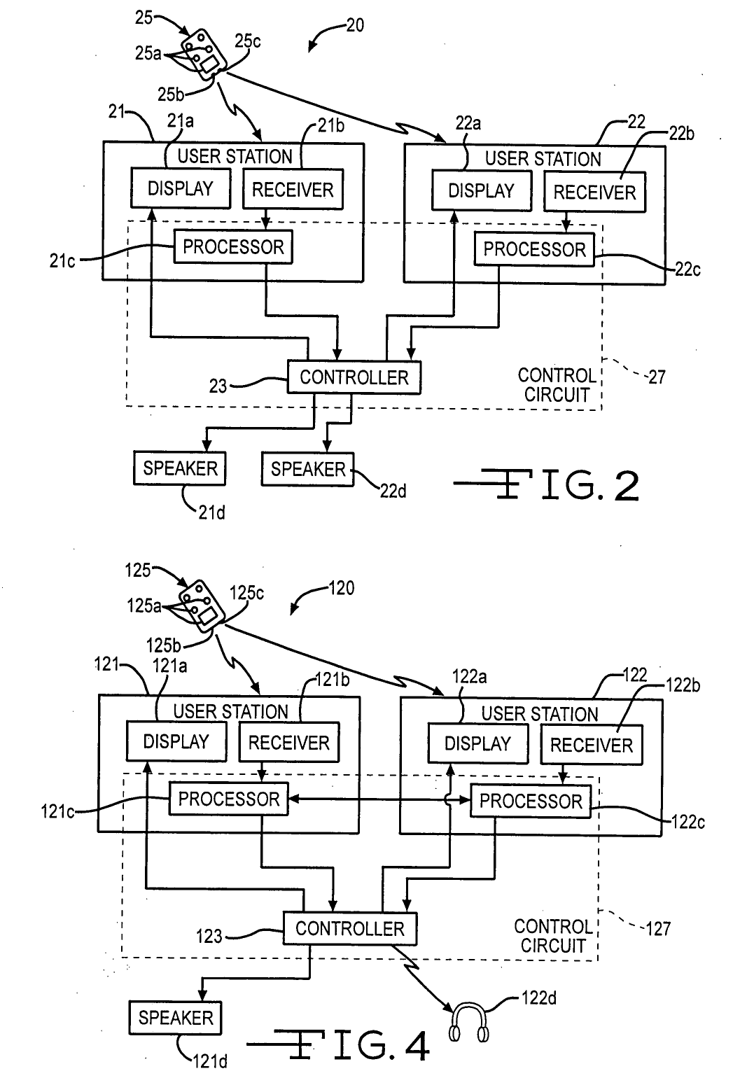

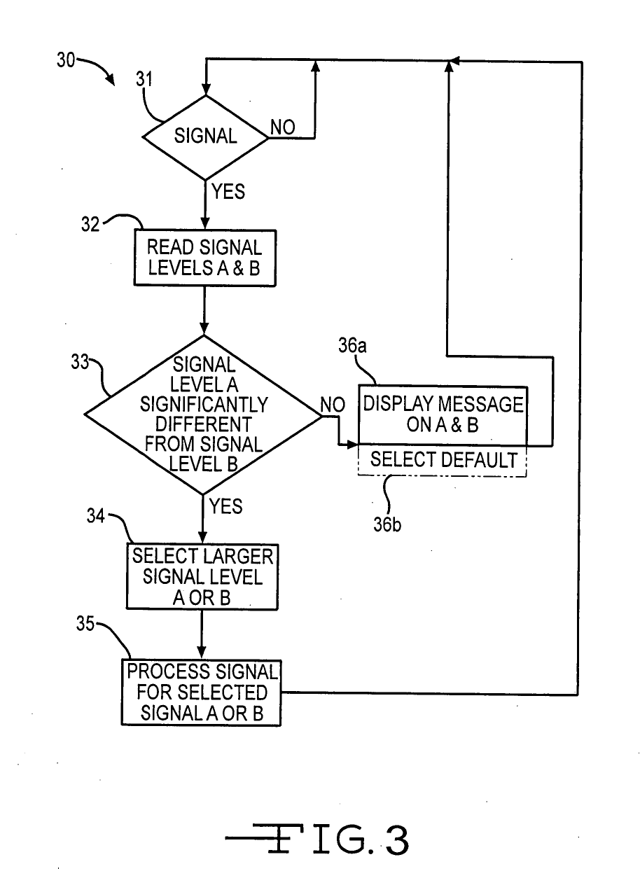

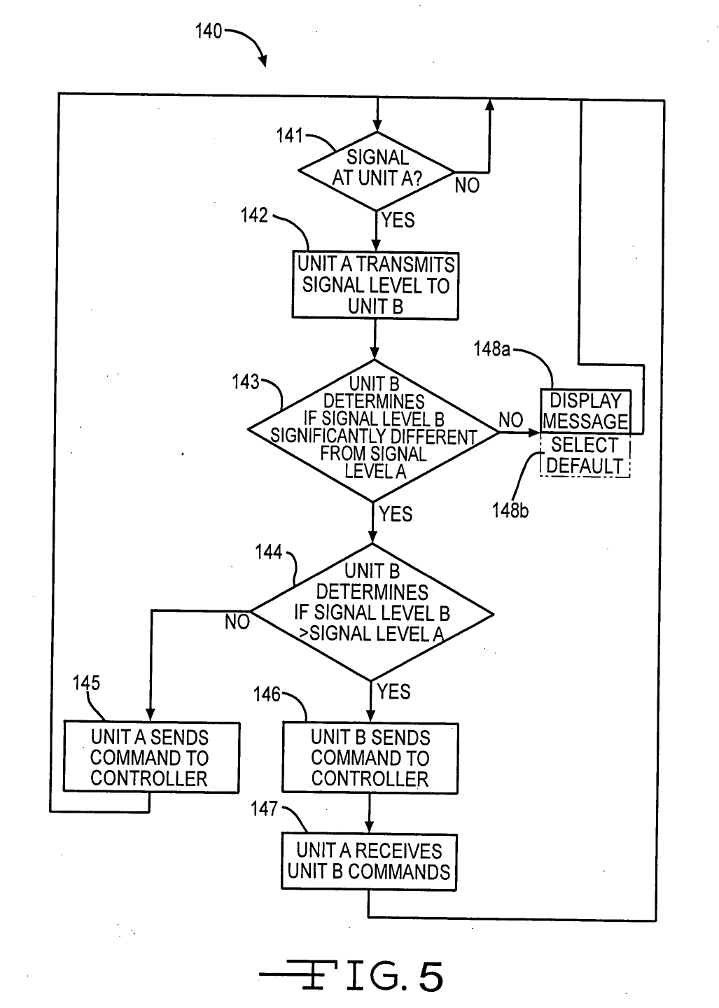

Referring now to FIG. 4, there is illustrated a second embodiment of a portion of an electronic system, indicated generally at 120, in accordance with the present invention. The electronic system 120 is similar to the electronic system 20 and generally only the components that differ will be described herein. Many of the components of the electronic system 120 as illustrated in FIG. 4 are similar in structure and function to corresponding components of the electronic system 20 as illustrated in FIGS. 1 and 2. Therefore, such corresponding components are indicated by similar reference number in these Figures, but with the components of the electronic system 120 as illustrated in FIG. 4 having the addition of 100 to each reference number.

The electronic system 120 includes a first user station 121 and a second user station 122. The first user station 121 includes a first display 121a, a first receiver 121b, and a first processor 121c. The first user station 121 may also include a first speaker 121d and/or other audio devices, such as a wireless headphone set (not shown). The second user station 122 includes a second display 122a, a second receiver 122b, and a second processor 122c. The second user station 122 may also include a wireless headset 121d and/or other audio devices, such as a speaker (not shown). The first user station 121 and the second user station 122 are connected to one another such that the first user station 121 and the second user station 122 can communicate with one another as will be described below.

The operation of the electronic system 120 will now be described. In a manner similar to that described for the prior embodiment, when a passenger (not shown) uses a user-manipulated device 125a on an input device 125 to select a desired command for the first user station 121, the input device 125 transmits a signal from a transmitter 125b that is provided on the input device 125 and emits a selected remote control signal corresponding to the desired command outwardly from a first end 125c thereof. Because the first user station 121 and the second user station 122 are relatively close to one another, both the first receiver 121b and the second receiver 122b will receive the signal transmitted by the input device 125 even if the transmitter 125a of the input device 125 is directed toward one of the first receiver 121b and the second receiver 122b. However, for example, if the passenger (not shown) generally aims the input device 125 toward the first display 121a and the first receiver 21b, i.e. the desired user station to be controlled, the magnitude or level of signal received by the first receiver 121b will be greater than the signal level received by the second receiver 122b.

The first receiver 121b would receive this transmitted signal and, in response thereto, the first processor 121c would determine a value for the strength or magnitude of the signal that is received by the first receiver 121b. Continuing from the example above, because the input device 125 is aimed directly at the first receiver 121b, the magnitude of the transmitted signal that is received by the first receiver 121b is relatively large. A Value indicative of this relatively large signal magnitude received by the first receiver 121b is then transmitted to the second processor 122c by the first processor 121c.

Either in response to the signal transmitted by the input device 125 or in response to the signal transmitted by the first receiver 121b, the second processor 122c would determine a value for the strength or magnitude of the signal that is received by the second receiver 122b. Again referring to the above example, because the input device 125 is not aimed directly at the second receiver 122b, the magnitude of the transmitted signal that is received by the second receiver 122b is relatively small in comparison to the relatively large signal magnitude received by the first receiver 121b. Additionally, in accordance with any known manner or any manner described herein, the processor 122c then determines which of the signals received by the two receivers 121b and 122b from the input device 125 is larger in magnitude. In response to that determination, only the user station 121 or 122 that received the larger magnitude signal from the input device 125 sends the desired command signal to a controller 123 of a control circuit 127. The controller 123 thereafter alters the operation of only the user station 121 because that user station 121 received the larger magnitude signal from the input device 125.

Referring now to FIG. 5, there is illustrated a flow chart, indicated generally at 140, of a method for operating the second embodiment of the electronic system illustrated in FIG. 4. In a first step 141 of the method 140, the first processor 121c determines if any signal has been received by the first receiver 121b from the input device 125. The signal level received at the first user station 121 and the second user station 122 are referred to, respectively, as signal level A and signal level B in FIG. 5. If no such signal has been received by the first receiver 121b from the input device 125, then the method 140 loops back to the first step 141. Thus, the first processor 121c continuously checks to see if a signal has been received by the first receiver 121b from the input device 125.

If such a signal has been received by the first receiver 121b from the input device 125, then the method 140 branches from the first step 141 to a second step 142, wherein the first processor 121c transmits a signal indicative of the signal level received at the first receiver 121b to the second processor 122c. It will be appreciated that the first processor 121c may include circuitry to determine a value for the magnitude of the signal received by the first receiver 121b. Additionally, the first processor 121c may include circuitry to decode the signal, although such is not required. It will further be appreciated that the first processor 121c may transmit additional data to the second processor 122c, although such is not required. Then, the method enters a third step 143, wherein the processor 122c of the second user station 122 determines if the signal level received by the first receiver 121b is significantly different than the signal level received by the second receiver 122b. It will be appreciated that the second processor 122c may include circuitry to determine a value for the magnitude of the signal received by the second receiver 122b. Additionally, the second processor 122c may also include circuitry to decode the signal received by the second receiver 122b from the input device 125, although such is not required. It will also be appreciated that the second processor 122c may include circuitry to analyze and compare the signal levels received by the first receiver 121b and the second receiver 122b. As described above, the signal that is received by each of the receivers 121b and 122b can be digitized using a predetermined number of significant digits to adequately represent the magnitude of the signal that is received at each of the receivers 121b and 122b, and, optionally, the desired function to be performed. The second processor 122c may be programmed with a threshold value, such that the difference between the signal levels for either or both of the first and second receivers 121b and 122b must be greater than or equal to the stored threshold value in order for the signal levels to be determined to be significantly different. It will be appreciated that the second processor 122c may determine whether or not the signal levels for the first and second receivers 121b and 122b are significantly different by any conventional method.

If, in the third step 143 of the method 140, the second processor 122b determines that the signal level for the first receiver 121a is significantly different than the signal level for the second receiver 121b, then the method 140 branches to a fourth step 144. In this fourth step 144, the second processor 122c determines if the signal level received by the second receiver 122b has a larger magnitude than the signal level received by the first receiver 121b. If the signal level received by the second receiver 122b does not have a larger magnitude than the signal level received by the first receiver 121b, then the second processor 122c sends a command or indication to the first processor 121c to send the desired function or command code which corresponds to the signal received by the first receiver 121b to the controller 123. In the above illustration, the first receiver 121b received a larger magnitude signal than the second receiver 122b because a passenger (not shown) aimed the input device 125 directly at the first receiver 121b. Thus, in this instance, the first processor 121c would, in a fifth step 145 of the method 140, send the desired command to the controller 123 and the controller 123 would then process and implement the desired command (“INCREASE VOLUME”, as mentioned above) for the first user station 121. The controller 123 would not cause any change in the operation of the second user station 122 because the lesser magnitude of the signal received by the second receiver 122b indicates that no change in the operation thereof was desired. Thereafter, the method 140 returns to the first step 141, and the entire process is repeated.

If, however, in the fourth step 144 of the method 140, it is determined that the signal level received by the second receiver 122b has a larger magnitude than the signal level received by the first receiver 121b, then the second processor sends the desired function or command code which corresponds to the signal received by the second receiver 121b to the controller 123, as indicated at a sixth step 146 of the method 140. The controller 123 would then process and implement the desired command for the second user station 122. The controller 123 would not cause any change in the operation of the first user station 121 because the lesser magnitude of the signal received by the first receiver 121b indicates that no change in the operation thereof was desired. Then, the method enters a seventh step 147, wherein the first processor 121c receives the signal sent by the second processor 122c to the controller 123, although such is not required. After receiving and transmitting the received signal to the second processor 122c, the first processor 121c may wait for a response from the second processor 122c indicating either to send the received command to the controller 123 as indicated in step 145 or indicating that the second processor 122c will send or has sent the received command to the controller 123 and the first processor does not need to take any further action. It will be appreciated that the first receiver 121c may return to normal operation after transmitting a received signal to the second processor 122c in step 142 and will only begin additional actions in response to commands received from the second processor 122c, such as the command sent in step 145. The first processor 121c may not require the receipt and/or monitoring of the command sent from the second processor 122c to the controller 123, thus making step 147 optional. If the step 147 is completed or omitted, thereafter, the method 140 returns to the first step 141, and the entire process is repeated.

Referring again to the third step 143, it will be appreciated that the second processor 122c may compare the signal levels for user station 121 and user station 122, and, if a difference in signal level is distinguishable, the method may advance to step 144. Thus, the second processor 122c may compare the signal levels in the third step 143 without regard to any threshold value used to establish whether the signal levels are significantly different. It will be appreciated that the controller 123 may determine if the signal levels are significantly different by any known method. It will further be appreciated that the step 143 may be omitted such that the method 140 advances from step 142 to step 144, wherein the signal levels for user station 121 and user station 122 are compared directly without regard to a significant difference between the signal levels. It will also be appreciated that the comparison of the signal levels received by the user station 121 and the user station 122 may be performed on an analog signal basis.

If, however, in the third step 143 of the method 140, the second processor 122c determines that the signal level for the first receiver 121a is not significantly different than the signal level for the second receiver 121b, then the method 140 branches to an eighth step 148. In this eighth step 148, the second processor 122c or the controller 123 may display a message on the displays 121a and 122a of both of the user stations 121 and 122, respectively, as indicated at 148a. Such a message may, for example, advise the passenger (not shown) that no action is being taken because the second processor 122c is not able to determine which of the user stations 121 and 122 is desired to change operation. However, the message may contain any desired information. Thereafter, the method 140 returns to the first step 141, and the entire process is repeated. Alternatively, then the second processor 122c may select a default one of the first and second user stations 121 and 122 for changing the operation thereof, as indicated at 148b. It will be appreciated that the default user station may be determined and stored according to any conventional method. Thereafter, the method 140 returns to the first step 141, and the entire process is repeated. In another alternative embodiment, the method 140 may simply return directly back to the first step 141, and the entire process is repeated.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. An electronic system comprising:
a first user station that receives a signal at a first magnitude;
a second user station that receives the signal at a second magnitude;
a control circuit that is responsive to the first and second magnitudes of the signal for determining one of the first and second user stations to process the signal.

2. The electronic system according to claim 1, further including an input device that generates the signal.

3. The electronic system according to claim 1, wherein the control circuit determines whether a significant difference exists between the first and second magnitudes of the signal for determining the one of the first and second user stations to process the signal.

4. The electronic system according to claim 1, wherein said control circuit determines whether a difference between the first and second magnitudes of the signal is greater than a threshold value for determining the one of the first and second user stations to process the signal.

5. The electronic system according to claim 1, wherein said control circuit determines the larger of the first and second magnitudes of the signal for determining the one of the first and second user stations to process the signal.

6. The electronic system according to claim 5, wherein said control circuit determines a predetermined one of the first and second user stations to process the signal if the control circuit is unable to determine the larger of the first and second magnitudes of the signal.

7. The electronic system according to claim 5, wherein said control circuit displays a message if the control circuit is unable to determine the larger of the first and second magnitudes of the signal.

8. The electronic system according to claim 1, wherein said control circuit includes a controller, and wherein the first user station generates a first signal that is representative of the first magnitude to the controller, and wherein the second user station generates a second signal that is representative of the second magnitude to the controller, and wherein the controller is responsive to the first and second signals for determining one of the first and second user stations to process the signal

9. The electronic system according to claim 1, wherein said second user station includes said control circuit, such that said control circuit receives the signal and determines the second magnitude, and further wherein said first user station transmits a signal indicative of said first magnitude to said control circuit so that said control circuit determines one of said first user station and said second user station to process the signal.

10. The electronic system according to claim 1, wherein the signal is one of an infrared signal and a radio frequency signal.

11. An electronic system comprising:
an input device operable to generate a signal;
a plurality of user stations each having a receiver operable to receive said signal from said input device;
a control circuit operable to determine which of said plurality of user stations is to be operated based on the magnitude of said signal received at each of said plurality of user stations.

12. A method of operating an electronic system including the steps of:
(a) providing an electronic system having a first user station and a second user station;
(b) generating a signal representing a desired command for one of the first user station and the second user station from an input device;
(c) determining the magnitude of the signal level received at the first user station;
(d) determining the magnitude of the signal level received at the second user station; and
(e) determining one of the first user station and the second user station to process the desired command based on the signal level received at each of the first receiver and the second receiver.
